(19) United States
(12) Patent Application Publication
(10) Pub. No.: US 2006/0149766 A1
(43) Pub. Date: Jul. 6, 2006

(54) Method and an apparatus to improve processor utilization in data mining

(76) Inventors: Amol Ghoting, Columbus, OH (US); Anthony D. Nguyen, Mountain View, CA (US); Daehyun Kim, San Jose, CA (US); Yen-Kuang Chen, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,775

(22) Filed: Dec. 30, 2004

(51) Int. Cl. G06F 17/30

(52) U.S. Cl. 707/101

(57) ABSTRACT

A method and an apparatus to improve processor utilization in data mining have been disclosed. In one embodiment, the method includes representing a transaction data set with a prefix tree, and allocating the prefix tree in a depth first search order in a memory of the computing system during data mining of the transaction data set. Other embodiments have been claimed and described.

### TECHNICAL FIELD

Embodiments of the invention relate generally to improving processor efficiency, and more particularly, to improving processor utilization in data mining.

### BACKGROUND

Over the past decade, the ability to gather, collect, and distribute data has resulted in large dynamically growing data sets and discovering knowledge hidden in these ever-growing data sets has become a pressing problem. Data mining refers to the effort of deriving useful information from these large data sets. Typically, data mining is interactive to facilitate effective data understanding and knowledge discovery. Thus, response time is crucial as lengthy delays between responses to two consecutive user requests can disturb the flow of human perception and the formation of insight. Since data mining is a computational, memory, and input/output (I/O) intensive process, providing users with a short interactive response time is a difficult task.

Frequent itemset mining is a popular data mining approach for a wide range of data mining tasks, ranging from market basket data analysis to fraud and intrusion detection. In general, frequent itemset mining is the task of identifying items or values that co-occur frequently in a data set. Suppose I is a set of items and D is a data set of transactions, where each transaction contains a set of items. A set of items is also known as an itemset. An itemset with k items is also known as a k-itemset. The support of an itemset X, denoted by sup(X), is the number of transactions in D in which X occurs as a subset. An l length subset of an itemset is called an l-subset. An itemset is frequent if its support is more than or equal to a user-specified minimum support value. A frequent itemset is a maximal frequent itemset (MFI) if it is not a subset of any frequent itemset. Frequent itemset mining typically involves generating all frequent itemsets in the data set, which have support greater than or equal to the specified minimum support value.

Consider the following example, where I={A, C, D, T, W} and D=T1: A C T W; T2: C D W; T3: A C T W; T4: A C D W; T5: A C D T W; T6: C D T. For a minimum support value of 6, the only frequent itemset in the current example is C. For a minimum support value of 3, the frequent itemsets are A, C, D, T, W, AC, AT, AW, CT, CD, CW, DW, TW, ACT, ACW, ATW, CDW, CTW and ACTW. Furthermore, CDW and ACTW are the MFIs. Note that given m items, there can be potentially 2^{m} frequent itemsets and efficient approaches are needed to traverse this exponential search space. There have been two distinct approaches to tackle this problem. The first approach, Apriori, uses a breadth first search strategy, while the second approach, Eclat, uses a depth first search strategy.

All the itemsets in a data set together with their dependencies can be represented in a lattice 100 as shown in FIG. 1. The connecting lines 110 in the lattice represent dependencies between k-itemsets and (k-1)-itemsets. Note that a k-itemset is frequent only if all of its constituting (k-1)-itemsets are frequent.

One goal of frequent itemset mining is to find all the frequent itemsets in the lattice by looking at the least number of itemsets, which can be exponential in the worst case. To check if an itemset is frequent, the support of the itemset in the data set is explicitly counted, which requires a data set scan in the worst case.

Conventionally, finding the support for an itemset in the data set is a critical step in the itemset mining process. Essentially, in the first pass, all frequent-1 items are found, and in the second pass, a prefix tree representation of the data set is built using only the frequent-1 items. The prefix tree in the above example for support=1 is constructed as follows. First, all frequent-1 items and their support are determined, which are: (item:support)—(A:4) (C:6) (D:4) (T:4) (W:5). Then the items are reordered based on their support as (C:6) (W:5) (A:4) (D:4) (T:4). Each transaction is then sorted based on the re-ordered set of items and the items are inserted recursively using common prefixes into a conventional prefix tree 200 as shown in FIG. 2.

One benefit of using a prefix tree is that the prefix tree provides a smaller representation of the data set that contains all the information required to find frequent itemsets. In the horizontal and vertical data formats, the size of the data set to be processed is proportional to the number of transactions. Using prefix trees, the size of the data set to be processed is reduced to some function of the number of frequent-1 items in the data set, which is much smaller for many practical purposes. One can find the frequency count for an itemset by traversing only a subset of the prefix tree nodes based on items seen through the search. However, a disadvantage of the prefix tree is that the prefix tree can lead to pointer chasing because the prefix tree is a pointer-based data structure. Furthermore, a cache line is typically not used entirely every time it is fetched, resulting in poor cache utilization.

### BRIEF DESCRIPTION OF THE DRAWINGS

Embodiments of the present invention is illustrated by way of example and not limitation in the figures of the accompanying drawings, in which like references indicate similar elements and in which:

FIG. 1 shows a conventional itemset lattice;

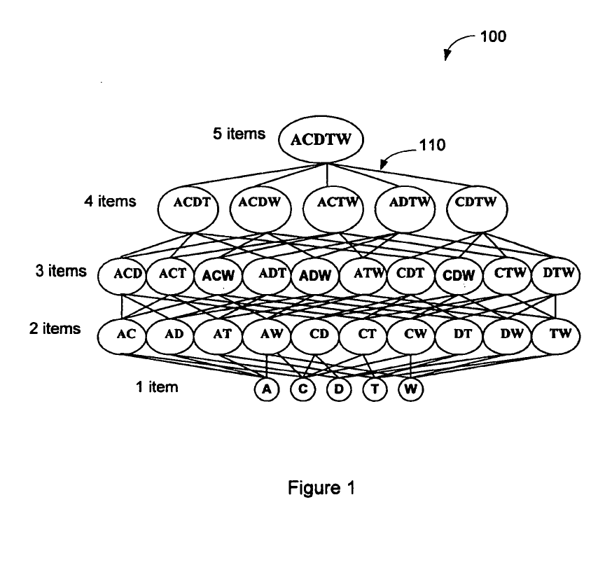

FIG. 2 shows a conventional prefix tree;

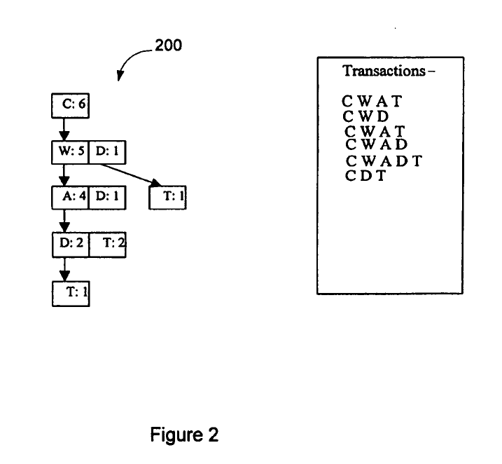

FIG. 3A illustrates one embodiment of a process to perform data mining on a prefix tree representing a set of transaction data;

FIG. 3B illustrates one exemplary embodiment of a process to generate a prefix tree;

FIG. 3C illustrates one exemplary embodiment of a process to perform a depth-first traversal of a prefix tree;

FIG. 3D illustrates an exemplary embodiment of a prefix tree;

FIG. 4 illustrates a flow diagram of one embodiment of a process to find the MFIs using the DFS traversal of the problem search space;

FIG. 5 illustrates one example of how the problem search space is traversed using one embodiment of backtracking search;

FIGS. 6A and 6B illustrate an exemplary prefix tree accessed by a first task and a second task respectively; and

FIG. 7 illustrates an exemplary embodiment of a computing system.

### DETAILED DESCRIPTION

A method and an apparatus to improve processor utilization in data mining are disclosed. In the following detailed description, numerous specific details are set forth in order to provide a thorough understanding. However, it will be apparent to one of ordinary skill in the art that these specific details need not be used to practice some embodiments of the present invention. In other circumstances, well-known structures, materials, circuits, processes, and interfaces have not been shown or described in detail in order not to unnecessarily obscure the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

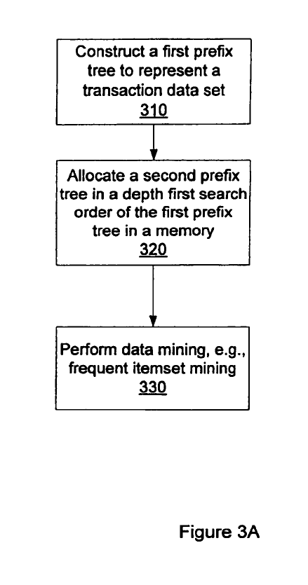

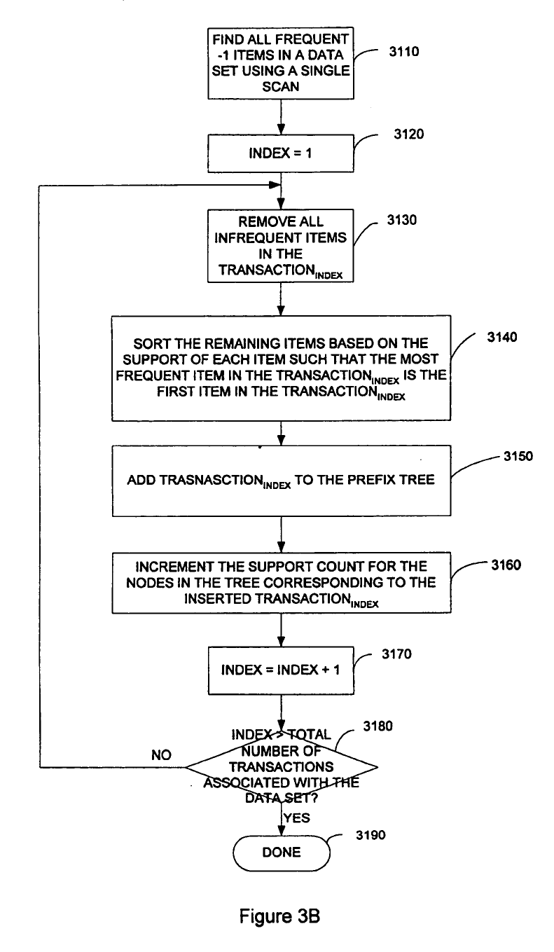

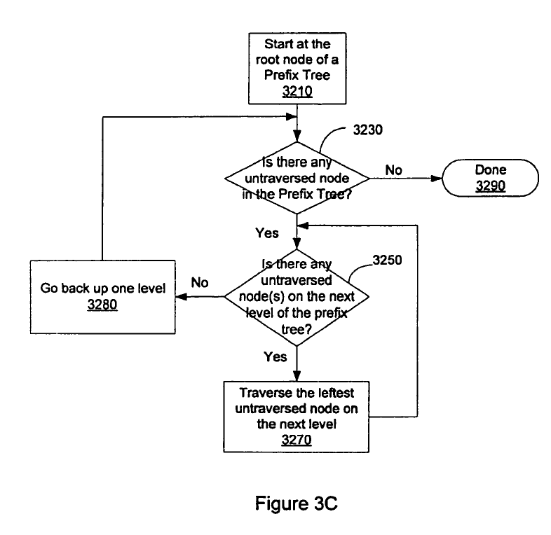

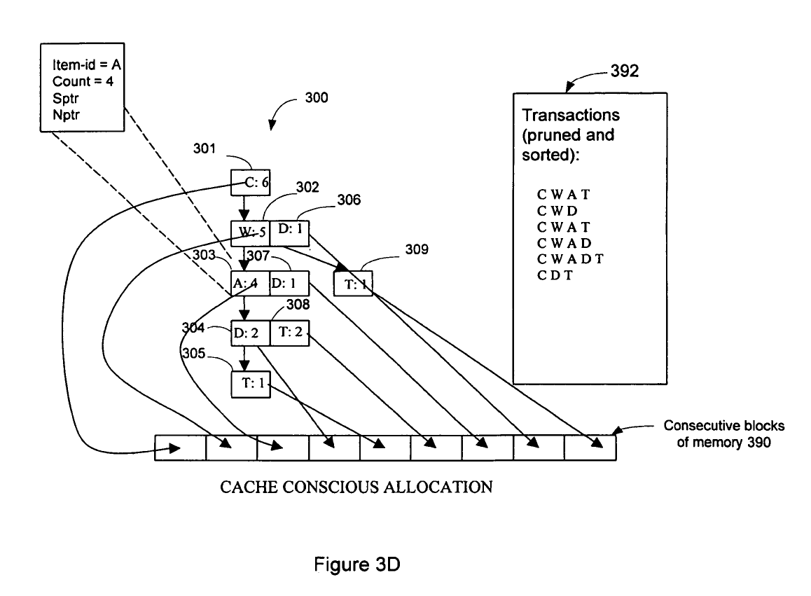

FIG. 3A shows one embodiment of a process to perform data mining on a prefix tree representing a set of transaction data. The process is performed by processing logic that may comprise hardware (e.g., circuitry, dedicated logic, etc.), software (such as a program operable to run on a general-purpose computer system or a dedicated machine), or a combination of both.

In one embodiment, processing logic generates a first prefix tree to represent the transaction data set (processing block 310). More details of the generation of a prefix tree are described below with reference to FIG. 3B. Then processing logic allocates a second prefix tree in a memory in a depth first search (DFS) order of the first prefix tree (processing block 320). Note that the memory includes a data storage device in the computing system that performs the current process. The data storage device may comprise a variety of storage devices, such as dynamic random access memory (DRAM), synchronous DRAM (SDRAM), etc. The second prefix tree in the DFS order may also be referred to as a cache-conscious prefix tree. There may be various ways to determine the DFS order of a prefix tree. One exemplary embodiment of a process to determine the DFS order of a prefix tree includes performing a depth-first traversal of the prefix tree as illustrated in FIG. 3C, details of which are discussed below. Referring back to FIG. 3A, processing logic then performs data mining on the transaction data set using the second prefix tree in the memory (processing block 330).

FIG. 3B illustrates one embodiment of a process to generate a prefix tree to represent a data set. Note that there are a number of transactions associated with the data set and one of the transaction may be referred to as transactionᵢ, where i is an index of the transaction. The process in FIG. 3B may be performed by processing logic that may comprise hardware (e.g., circuitry, dedicated logic, etc.), software (such as a program operable to run on a general-purpose computer system or a dedicated machine), or a combination of both.

Referring to FIG. 3B, processing logic finds all frequent-1 items in a data set (processing block 3110). In some embodiments, processing logic uses a single scan to find all frequent-1 items. Then processing logic performs various operations to analyze each of the transactions associated with the data set. Processing logic may start with the first transaction by setting an index of the transactions, Index, to be 1 (processing block 3120).

Processing logic removes all infrequent items in transaction_{Index} (processing block 3130). Then processing logic sorts the remaining items based on the support of each item such that the most frequent item in transaction_{Index} is the first item in transaction_{Index} (processing block 3140). Processing logic then adds transaction_{Index} to the prefix tree (processing block 3150). In some embodiments, processing logic adds transaction_{Index} to the prefix tree by re-using the largest common prefix seen in the prefix tree and by allocating new nodes to accommodate for the remaining part of transaction_{Index}. Processing logic further increments the support count for the nodes in the prefix tree corresponding to the inserted transaction_{Index} (processing block 3160). Then processing logic increments Index by 1 (processing block 3170) and checks whether Index is greater than the total number of transactions associated with the data set (processing block 3180). If not, processing logic transitions back to processing block 3130 to repeat the operations for the next transaction. If yes, then the process ends (processing block 3190).

FIG. 3C illustrates one embodiment of a process to perform a depth-first traversal of a prefix tree in order to determine the DFS order of the prefix tree. Note that the prefix tree may include a root node and a number of nodes. The order in which the root node and the nodes are depth-first traversed is the DFS order of the prefix tree. The process in FIG. 3C may be performed by processing logic that may comprise hardware (e.g., circuitry, dedicated logic, etc.), software (such as a program operable to run on a general-purpose computer system or a dedicated machine), or a combination of both.

Referring to FIG. 3C, processing logic starts at the root node of the prefix tree (processing block 3210). Then processing logic determines whether there is any untraversed node in the prefix tree (processing block 3230). If there is none, then the process ends at processing block 3290. Otherwise, processing logic determines whether there is any untraversed child node of the current node on the next level of the prefix tree (processing block 3250). If there is, then processing logic may traverse the leftest untraversed child node on the next level of the prefix tree (processing block 3270). Otherwise, processing logic goes back up by one level in the prefix tree (processing block 3280). Processing logic then transitions back to processing block 3230 to repeat the operations until all nodes in the prefix tree is traversed. The order in which the root node and the nodes of the prefix tree are traversed in the above process is referred to as the DFS order of the prefix tree.

FIG. 3D illustrates an exemplary embodiment of a prefix tree 300 having a number of nodes 301-309. The prefix tree 300 represents an exemplary data set and each of the nodes 301-309 corresponds to an item in the data set. The exemplary data set is associated with a number of transactions 392. In some embodiments, each of the nodes 301-309 includes an item identification (item-id), a support count of the item, one or more pointers to the node's sibling(s) in the prefix tree 300 (sptr), and one or more pointers to the node's child/children in the prefix tree 300 (nptr). In some other embodiments, the node may have pointers to multiple children, but no pointer to the node's sibling(s) in the prefix tree. For example, the node 303 has an item-id of “A” and a support count of 4. In some embodiments, the nodes 301-309 of the prefix tree 300 are traversed in the DFS order as described in the following sequence: 301, 302, 303, 304, 305, 308, 307, 306, 309. Details of one embodiment of a process to determine the DFS order of a prefix tree are discussed above with respect to FIG. 3C. The nodes 301-309 are stored in the DFS order in the consecutive blocks of memory 390.

In some embodiments, the prefix tree 300 is accessed repeatedly through support counting in data mining. Since the first prefix tree is a pointer-based structure and the first prefix tree may not be cache efficient, thus, a large number of cache misses, such as L2 and L3 cache misses, may result from accesses in support counting. It is because each node of the first prefix tree is traditionally allocated individually in the memory and a large number of cache misses may result. To mitigate the problem of cache misses during the accesses in support counting due to inefficient cache usage, the nodes 301-309 are stored in a cache-conscious manner. For example, the nodes 301-309 may be stored in the memory according to the DFS order of the prefix tree 300 as shown in FIG. 3D. This may increase cache line efficiency because accesses to the prefix tree 300 typically follow the DFS order during support counting. As a result, much of the data in a cache line fetched may be used in a majority of the accesses during support counting. Thus, a prefix tree allocated in the DFS order is one example of a cache-conscious prefix tree. Furthermore, the improved cache line efficiency improves the overall cache utilization as more data can be placed in the cache and be reused when needed. Consequently, the cache miss rate may be reduced drastically.

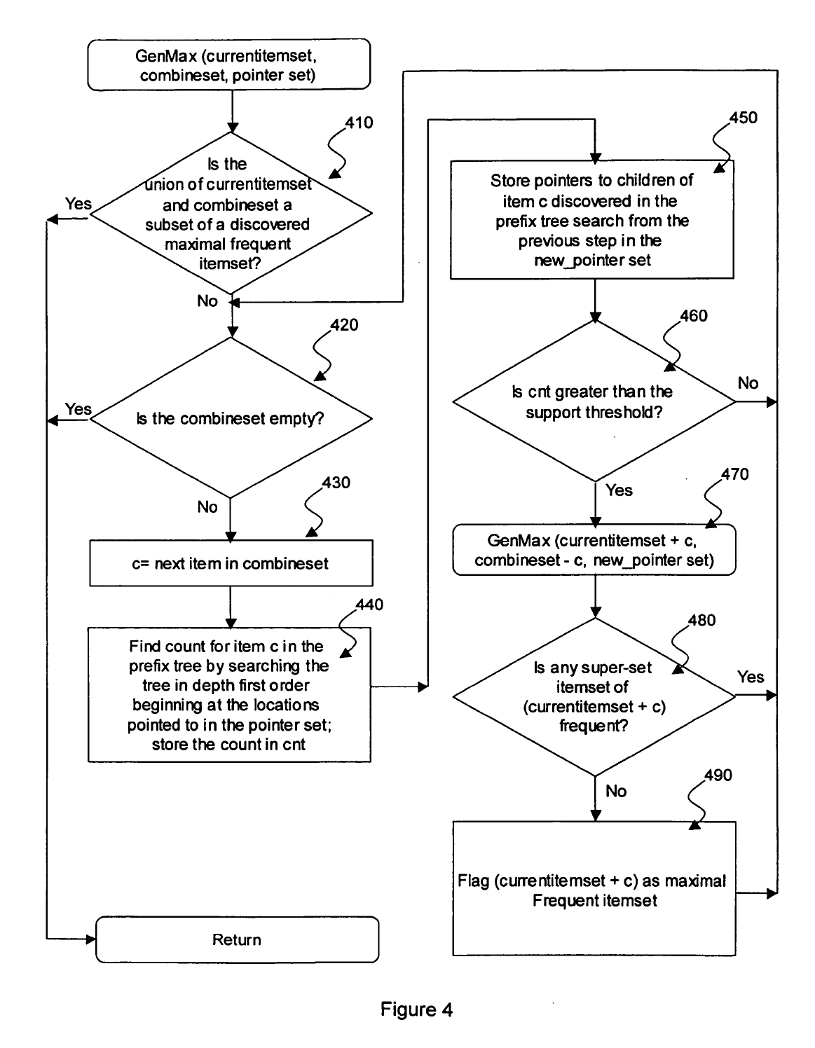

Frequently in data mining of a transaction data set, maximal frequent itemsets (MFIs) in the transaction data set have to be found. According to some embodiments of the invention, the MFIs are found using a DFS traversal of the problem search space. The flow diagram of one embodiment of a process to find the MFIs using the DFS traversal of the problem search space is illustrated in FIG. 4. In some embodiments, the process is referred to as GenMax. The process is implemented by processing logic, which may include hardware, software, or a combination of both. Furthermore, one of ordinary skill in the art would recognize that the process is not limited to any particular programming language.

In some embodiments, a backtracking search of the problem search space to discover the MFIs is utilized. When using the backtracking search, two sets are maintained, namely currentitemset and combinset. This search may be carried out recursively. Processing logic checks whether the union of currentitemset and combineset (currentitemset+combineset) is a subset of a discovered MFI (processing block 410). If yes, the process ends. Otherwise, processing logic checks whether combineset is empty (processing block 420). If combineset is empty, the process ends. Otherwise, processing logic transitions to processing block 430.

Processing logic extends currentitemset with one element, c, in combineset at a time (processing block 430). Then processing logic finds the count for the item c in the prefix tree (processing block 440). In some embodiments, processing logic searches the tree in depth first order beginning at the locations pointed to in the pointer set and stores the count in cnt. Then processing logic stores pointers to children of the item c discovered in the prefix tree search from processing block 440 in the new_Pointer set (processing block 450).

Processing logic checks whether cnt is greater than the support threshold (processing block 460). In other words, processing logic checks to see if currentitemset with this extension is frequent. If currentitemset with this extension is frequent, processing logic continues deeper into the recursion with this extended currentitemset and the remainder of combineset (processing block 470). If currentitemset with this extension is not frequent, then processing logic extends currentitemset with the next item in combineset and proceeds to processing block 420. The length of currentitemset may be the same as the depth of the node in the prefix tree. In some embodiments, the recursion continues as long as combineset is not empty (which is checked in processing block 420). Processing logic checks whether any of the super-set itemsets of the union of currentitemset and c is frequent (processing block 480). If no, processing logic flags the union of currentitemset and c as a MFI (processing block 490) and then transitions back to processing block 420. Otherwise, processing logic transitions back to processing block 420.

In some embodiments, when finding the support for an itemset, processing logic may not have to start counting in the prefix tree beginning at the root every time. Rather, processing logic may start at the child nodes of the item that has been searched for in the previous level of the recursion. This may be accomplished by storing the required child pointers in the new_pointer set (as illustrated in processing block 450). The new_pointer set may be passed on through the recursion.

In some embodiments, the entire problem search space may not be traversed. If currentitemset is frequent (as determined in processing block 460) and the union of currentitemset and combineset is not a subset of a discovered MFI (as determined in processing block 410), then processing logic may proceed with the recursion through the search space.

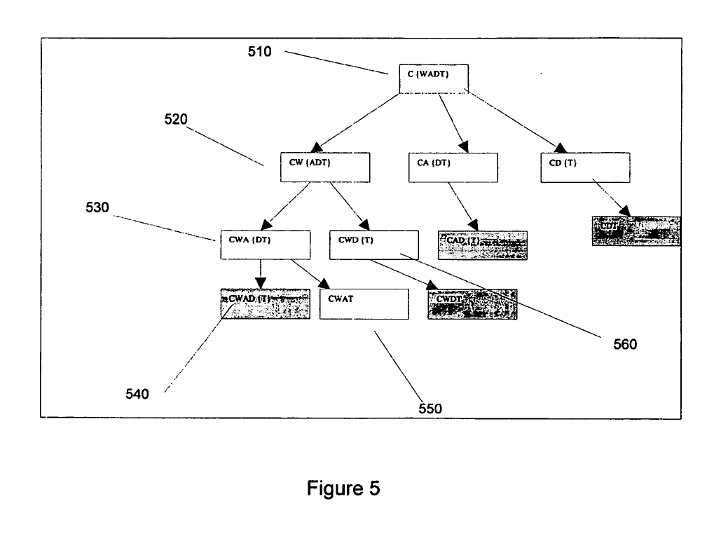

FIG. 5 illustrates an example of how the problem search space is traversed using one embodiment of a backtracking search. In the example, currentitemset={C} and combineset={W A D T} 510 initially. As currentitemset is frequent, currentitemset is extended with W to create a currentitemset={C, W}, and the combineset becomes {A D T} 520. As {C W} is frequent, currentitemset is extended with A to create currentitemset={C W A}, and combineset becomes {D T} 530. This is an example of depth first problem space traversal.

Through the traversal when currentitemset={C W A D} and combineset={T} 540, processing logic does not go deeper in the recursion as the currentitemset is not frequent. Also, CWAT 550 and CWD 560 are reported as MFIs as they have no frequent supersets. Note that the situation in which currentitemset={C} and combineset={T} is not considered because the union of currentitemset and combineset has been subsumed by a previously discovered MFI CWAT 550.

To further illustrates the technique which avoids counting in the prefix tree beginning at the root every time a support count is determined, consider the following example with reference to FIG. 5. When finding the support count for an itemset C 510 for the first time, processing logic may first search for all occurrences of C in the prefix tree. Once processing logic finds C, processing logic stores pointers of the child nodes of C in a new pointer set. In the next level 520, when searching for frequency for CW, processing logic begins at the child nodes of C stored in the new_pointer set that is passed on in pointer set, through the recursion. Thus processing time can be saved by not starting the search on the portion of the prefix tree that has already been searched once.

The search for MFIs may be parallelized in a shared memory model of a computing system. To improve efficiency, the synchronization between threads may be reduced. Furthermore, to achieve good data locality within an individual thread, distinct backtracking search trees (an example of which is shown in FIG. 5) may be assigned to each of the threads. Thus, there is no dependence between the threads as each backtracking search tree corresponds to a disjoint set of candidates. There may be no synchronization required while searching for the MFIs, except when updating the set of MFIs, which is typically a rare event. In one embodiment, each thread picks the next available search tree in a queue of backtracking search trees sorted based on the support of the frequent 1 item in currentitemset.

Furthermore, improved cache efficiency may result in better data reuse within the same thread of execution. For instance, part of the prefix tree used to find the support count for an itemset (such as CWA 530) may also be reused to find the support count for an itemset (such as CWD 560). Reusing more data in the cache line allows better cache utilization, eases the bus bandwidth requirements, and reduces the cache miss rate, such as the L2 and L3 cache miss rates.

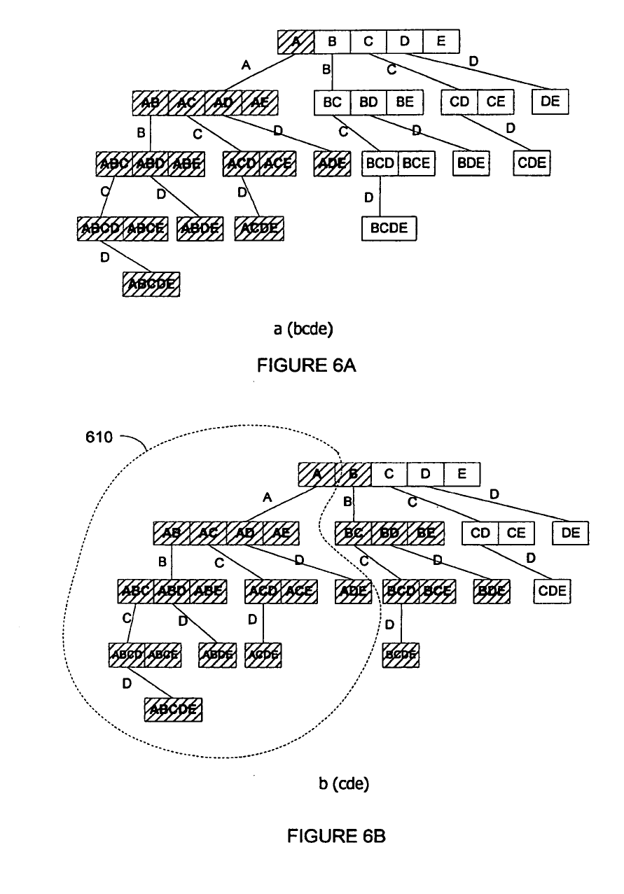

Just as data may be reused within a thread, data may also be shared between threads. For example, there are two tasks, namely, a {b c d e} and b {c d e} assigned to two different threads. FIGS. 6A and 6B illustrate an exemplary prefix tree accessed by the two tasks, respectively, in the current example. Note that the prefix tree in Figures 6A and 6B is a different example from the one shown in FIG. 5. The shaded prefix tree nodes in FIG. 6A are accessed by the first task, and the shaded prefix tree nodes in FIG. 6B are accessed by the second task. As can be seen, there is a significant number of overlapped nodes 610 in the prefix tree being accessed by both tasks as shown in FIG. 6B. For some transaction data sets with over a thousand parallel tasks, larger portions of data reuse can be identified. To take advantage of the reusable data, these tasks, a {b c d e} and b {c d e}, can be co-scheduled on a multithreaded processor to allow a significant amount of cached data reuse. In one embodiment, a Simultaneous Multithreading (SMT) processor is a processor design that combines hardware multithreading with superscalar processor technology to allow multiple threads to issue instructions each cycle. SMT permits all thread contexts to simultaneously compete for and share processor resources by maintaining several thread contexts on chip. One example of the SMT processor is Intel Pentium 4 processor with Hyper-Threading Technology provided by Intel Corporation in Santa Clara, Calif. Co-scheduling the tasks on the SMT processor may improve the scalability of the tasks. Furthermore, it may be possible to achieve super-linear speedup in some embodiments. In an alternative embodiment, a chip-multiprocessor (CMP) that has two or more processor cores on a single chip with shared caches is used.

Note that the above technique is applicable to many data mining routines in different embodiments. For example, the above technique can be applied to apriori, genmax, FP-growth, etc.

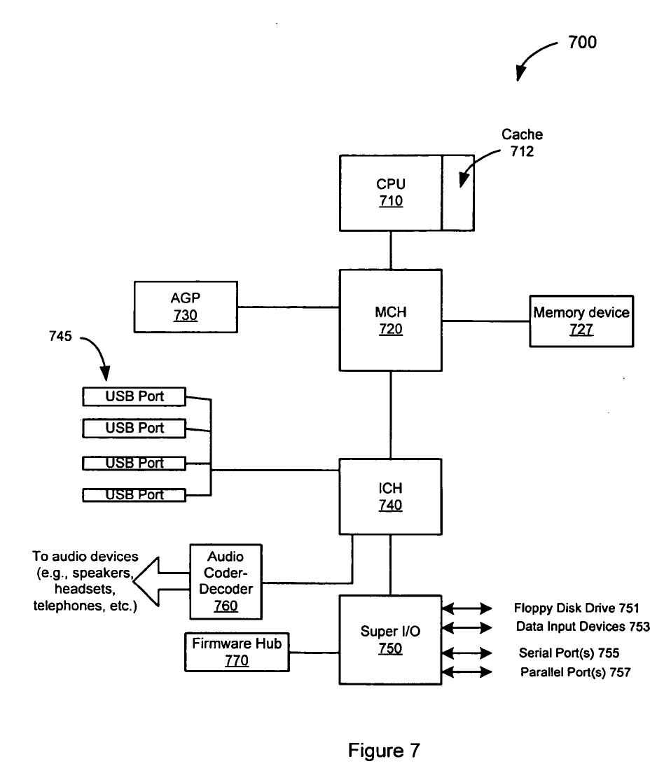

FIG. 7 shows an exemplary embodiment of a computer system 700 usable with some embodiments of the invention. The computer system 700 includes a central processing unit (CPU) 710, a memory controller (MCH) 720, a memory device 727, a graphic port (AGP) 730, an input/output controller (ICH) 740, a number of network interfaces (such as Universal Serial Bus (USB) ports 745, Super Input/Output (Super I/O) 750, etc.) an audio coder-decoder 760, and a firmware hub (FWH) 770.

In one embodiment, the CPU 710, the graphic port 730, the memory device 727, and the ICH 740 are coupled to the MCH 720. The MCH 720 routes data to and from the memory device 727. The memory device 727 may include various types of memories, such as, for example, dynamic random access memory (DRAM), synchronous dynamic random access memory (SDRAM), double data rate (DDR) SDRAM, etc. In one embodiment, the USB ports 745, the audio coder-decoder 760, and the Super I/O 750 are coupled to the ICH 740. The Super I/O 750 may be further coupled to a firmware hub 770, a floppy disk drive 751, data input devices 753 (e.g., a keyboard, a mouse, etc.), a number of serial ports 755, and a number of parallel ports 757. The audio coder-decoder 760 may be coupled to various audio devices, such as speakers, headsets, telephones, etc.

In some embodiments, the CPU 710 is coupled to a cache 712 to temporarily store data fetched from the memory device 727. The CPU 710 may or may not include a SMT processor. The cache 712 may or may not reside on the same substrate with the CPU 710. When the CPU 710 performs data mining on a transaction data set stored in the memory device 727, the CPU 710 may fetch a cache line of data from the memory containing at least a portion of the transaction data set and temporarily store the cache line of data in the cache 712. More details of various embodiments of the processes to store the prefix tree representing the transaction data set in the memory device 727, to access the data from the memory, and to perform data mining on the transaction data set have been described in details above.

Note that any or all of the components and the associated hardware illustrated in FIG. 7 may be used in various embodiments of the computer system 700. However, it should be appreciated that other configurations of the computer system may include one or more additional devices not shown in FIG. 7. Furthermore, one should appreciate that the technique disclosed is applicable to different types of system environment, such as a multi-drop environment or a point-to-point environment. Likewise, the disclosed technique is applicable to both mobile and desktop computing systems.

Some portions of the preceding detailed description have been presented in terms of symbolic representations of operations on data bits within a computer memory. These descriptions and representations are the tools used by those skilled in the data processing arts to most effectively convey the substance of their work to others skilled in the art. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purposes, or it may comprise a general-purpose computer selectively activated or reconfigured by a computer program stored in the computer. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A method comprising:
representing a transaction data set with a prefix tree; and
allocating the prefix tree in a depth first search order in a memory of a computing system during data mining of the transaction data set.

2. The method of claim 1, further comprising:
performing frequent itemset mining on the transaction data set during the data mining of the transaction data set.

3. The method of claim 2, wherein performing frequent itemset mining comprises:
performing a depth first search traversal of the prefix tree to find one or more maximal frequent itemsets.

4. The method of claim 3, further comprising:
fetching a cache line of data containing at least a portion of the prefix tree from the memory in response to a first request to access a first portion of the transaction data set during the data mining;
temporarily storing the cache line of data in a cache in the computing system; and
receiving a second request to access a second portion of the transaction data set subsequent to the first request, wherein the cache line of data stored in the cache includes the second portion of the transaction data set.

5. The method of claim 3, wherein performing the depth first search traversal of the prefix tree comprises:
determining a support count of an itemset in the second prefix tree;
remembering a point in the prefix tree at which the determining of the support count of the itemset terminates; and
continuing to search for a next itemset at the point remembered without going back to a root node of the prefix tree.

6. The method of claim 3, further comprises:
co-scheduling a plurality of tasks of the frequent itemset mining on a multithreaded processor, wherein the plurality of tasks share at least a portion of the data in the cache.

7. A method comprising:
co-scheduling a plurality of tasks in data mining of a transaction data set on a multithreaded processor, wherein the plurality of tasks share at least a portion of data in a cache of the multithreaded processor; and
fetching a cache line of data from a memory coupled to the multithreaded processor, the cache line of data containing at least a portion of the transaction data set.

8. The method of claim 7, further comprising:
representing the transaction data set with a cache-conscious prefix tree; and
storing the transaction data set in the memory based on the cache-conscious prefix tree.

9. The method of claim 8, wherein representing the transaction data set with the cache-conscious prefix tree comprises:
generating a first prefix tree to represent the transaction data set; and
allocating the cache-conscious prefix tree in a depth first search order of the first prefix tree in the memory.

10. A machine-accessible medium that provides instructions that, if executed by a processor, will cause the processor to perform operations comprising:
representing a transaction data set with a prefix tree; and
allocating the prefix tree in a depth first search order in a memory of a computing system during data mining of the transaction data set.

11. The machine-accessible medium of claim 10, wherein the operations further comprise:
performing frequent itemset mining on the transaction data set during the data mining of the transaction data set.

12. The machine-accessible medium of claim 11, wherein performing frequent itemset mining comprises:
performing a depth first search traversal of the prefix tree to find one or more maximal frequent itemsets.

13. The machine-accessible medium of claim 12, wherein performing the depth first search traversal of the prefix tree comprises:
determining a support count of an itemset in the prefix tree;
remembering a point in the prefix tree at which the determining of the support count of the itemset terminates; and
continuing to search for a next itemset at the point remembered without going back to a root node of the prefix tree.

14. The machine-accessible medium of claim 11, wherein the operations further comprise:
co-scheduling a plurality of tasks of the frequent itemset mining on a multithreaded processor, wherein the plurality of tasks share at least a portion of the data in the cache.

15. A machine-accessible medium that provides instructions that, if executed by a processor, will cause the processor to perform operations comprising:
co-scheduling a plurality of tasks in data mining of a transaction data set on a multithreaded processor, wherein the plurality of tasks share at least a portion of data in a cache of the multithreaded processor; and
fetching a cache line of data from a memory coupled to the multithreaded processor, the cache line of data containing at least a portion of the transaction data set.

16. The machine-accessible medium of claim 15, wherein the operations further comprise:
representing the transaction data set with a cache-conscious prefix tree; and
storing the transaction data set in the memory based on the cache-conscious prefix tree.

17. The machine-accessible medium of claim 16, wherein representing the transaction data set with the cache-conscious prefix tree comprises:
generating a first prefix tree to represent the transaction data set; and
allocating the first prefix tree in a depth first search order of the non-cache-conscious prefix tree in the memory.

18. A system comprising:
a processor;
a network interface coupled to the processor; and
a memory coupled to the processor to store a plurality of instructions that, if executed by the processor, will cause the processor to perform operations comprising:
representing a transaction data set with a prefix tree; and
allocating the prefix tree in a depth first search order in the memory during data mining of the transaction data set.

19. The system of claim 18, wherein the processor comprises a cache, wherein the operations further comprise:
fetching a cache line of data containing at least a portion of the prefix tree from the memory in response to a first request to access a first portion of the transaction data set during the data mining; and
temporarily storing the cache line of data in the cache; and
receiving a second request to access a second portion of the transaction data set subsequent to the first request, wherein the cache line of data stored in the cache includes the second portion of the transaction data set.

20. The system of claim 19, wherein the operations further comprise:
performing frequent itemset mining on the transaction data set during the data mining of the transaction data set.

21. The system of claim 20, wherein performing frequent itemset mining comprises:
performing a depth first search traversal of the second prefix tree to find one or more maximal frequent itemsets.

22. The system of claim 21, wherein performing the depth first search traversal of the prefix tree comprises:
determining a support count of an itemset in the prefix tree;
remembering a point in the prefix tree at which the determining of the support count of the itemset terminates; and
continuing to search for a next itemset at the point remembered without going back to a root node of the prefix tree.

23. The system of claim 21, wherein the processor comprises a multithreaded processor, wherein the operations further comprise:
co-scheduling a plurality of tasks of the frequent itemset mining on the multithreaded processor, wherein the plurality of tasks share at least a portion of the data in the cache.

24. A system comprising:
a multithreaded processor comprising a cache;
a network interface coupled to the multithreaded processor; and
a memory coupled to the multithreaded processor to store a plurality of instructions that, if executed by the processor, will cause the processor to perform operations comprising:
co-scheduling a plurality of tasks in data mining of a transaction data set on the multithreaded processor, wherein the plurality of tasks share at least a portion of data in the cache; and
fetching a cache line of data from the memory, the cache line of data containing at least a portion of the transaction data set.

25. The system of claim 24, wherein the operations further comprise:
representing the transaction data set with a cache-conscious prefix tree; and
storing the transaction data set in the memory based on the cache-conscious prefix tree.

26. The system of claim 25, representing the transaction data set with the cache-conscious prefix tree comprises:
generating a first prefix tree to represent the transaction data set; and
allocating the cache-conscious prefix tree in a depth first search order of the first prefix tree in the memory.

27. An apparatus comprising:
a memory; and
a processing circuitry coupled to the memory, the processing circuitry operable to allocate a prefix tree in a depth first search order in the memory to represent a transaction data set during data mining of the transaction data set.

28. The apparatus of claim 27, wherein the processing circuitry is operable to perform frequent itemset mining on the transaction data set during the data mining of the transaction data set.

29. The apparatus of claim 28, wherein the processing circuitry is operable to perform a depth first search traversal of the prefix tree to find one or more maximal frequent itemsets.

30. The apparatus of claim 29, wherein the processing circuitry is operable to determine a support count of an itemset in the prefix tree, remember a point in the prefix tree at which determining of the support count of the itemset terminates, and to continue to search for a next itemset at the point remembered without going back to a root node of the prefix tree.
